(19) United States
(12) Patent Application Publication
(10) Pub. No.: US 2007/0128049 A1
(43) Pub. Date: Jun. 7, 2007

(54) Jet pump apparatus for a vehicle fuel tank

(76) Inventors: Michel Sanchez, Tellancourt (FR); Hugues Cremer, Bastogne (BE); Rainer Metzen, Hosingen (LU)

Correspondence Address: DELPHI TECHNOLOGIES, INC., M/C 480-410-202, PO BOX 5052, TROY, MI, 48007, US

(21) Appl. No.: 11/496,188

(22) Filed: Jul. 31, 2006

(30) Foreign Application Priority Data
Dec. 1, 2005 (GB) 0524439.7

(51) Int. Cl. F04F 5/00; F02M 37/00

(52) U.S. Cl. 417/176; 123/514

(57) ABSTRACT

A jet pump apparatus for a vehicle fuel tank, the apparatus comprising a fuel manifold having a fuel inlet, connectable to a source of pressurised fuel, such as a fuel pump or fuel line, and a plurality of fuel outlets; a plurality of jet pumps, each jet pump having an inlet connectable to a fuel line for communication with a compartment of the fuel tank and an outlet adapted for fluid communication with a main compartment or reservoir containing a fuel pump inlet; each fuel outlet of the fuel manifold communicating with the throat region of a venturi of a respective one of the plurality of jet pumps.

### TECHNICAL FIELD OF INVENTION

The present invention relates to a jet pump apparatus for a vehicle fuel tank.

### BACKGROUND OF INVENTION

Internal combustion engine driven vehicles require fuel tanks to store a sufficient volume of fuel to give a reasonable driving range. In order to draw the maximum possible volume of fuel from the fuel tank, the inlet of the fuel pump must draw fuel from the lowest point of the fuel tank. The shape of such fuel tanks is largely determined by the available space and the need to fit around other components of the vehicle, such as suspension, drive shafts and exhaust systems. Often such shape constraints lead to the formation of a number of compartments within the fuel tank, separated by raised areas, for example a raised saddle to clear a drive shaft. Thus it is necessary to draw fuel from all of such separate compartments to maximise fuel capacity available to the fuel pump.

Such problem is usually overcome by the use of jet pumps that utilise the venturi effect to draw fuel from each isolated compartment to a single main compartment or to a separate reservoir in which the fuel pump is located, each jet pump being driven by a flow of fuel from the output of the fuel pump or by a return flow of over supplied fuel returned from the fuel rail. It is also necessary to provide an anti-siphoning check valve in the fuel supply pipe of each jet pump.

As shown in FIG. 1, a known jet pump apparatus for delivering fuel to the fuel pump 1 of a vehicle comprises a reservoir 2 in which the fuel pump 1 is located, three separate jet pumps 3,4,5 disposed in various compartments of the fuel tank for drawing fuel from each compartment to the fuel pump reservoir 2. Fuel delivered from the outlet of the fuel pump 1 is passed through a fuel filter assembly 6 and subsequently to the fuel system of the engine. A pressure regulator 7 is provided returning excess fuel to the fuel pump reservoir 2 when the fuel pressure exceeds a predetermined maximum.

The fuel is also supplied to a distributor 8 connected to separate transfer tubes 9 supply fuel to each of the jet pumps 3,4,5 to entrain fuel from the vicinity of each jet pump 3,4,5 to the fuel pump reservoir 2 by the venturi effect, as is well known in the art.

Known fuel delivery jet pump systems generally use “push-flow” jet pumps, wherein the pressurised fuel is supplied from a nozzle into the venturi throat and the surrounding fuel is entrained into the venturi throat from around the nozzle, upstream of the venturi. Such “push-flow” jet pumps generally require immersion in fuel to operate and thus require a pressurised fuel feed line and a downstream delivery line.

For complex fuel tank shapes multiple jet pumps are required, requiring numerous fuel supply lines and check valves requiring a high number of connections and expensive components. This leads to high costs and difficult in-tank assembly procedures.

### SUMMARY OF THE INVENTION

According to a first aspect of the present invention there is provided a jet pump apparatus for a vehicle fuel tank, the apparatus comprising a fuel manifold having a fuel inlet, connectable to a source of pressurised fuel, such as a fuel pump or fuel line, and a plurality of fuel outlets; a plurality of jet pumps, each jet pump having an inlet connectable to a fuel line for communication with a compartment of the fuel tank and an outlet adapted for fluid communication with a main compartment or reservoir containing a fuel pump inlet; each fuel outlet of the fuel manifold communicating with the throat region of a venturi of a respective one of the plurality of jet pumps.

Preferably said plurality of jet pumps are provided in a common body or housing. Preferably the fuel manifold is mounted on or formed integrally with said body. An anti-syphon check valve may be provided upstream of the fuel inlet of the manifold. Preferably each of said plurality of jet pumps comprises an aspiration jet pump.

According to a second aspect of the present invention there is provided a fuel delivery module comprising a fuel pump mounted within a fuel pump reservoir, a jet pump apparatus in accordance with said first aspect of the present invention, wherein said jet pump apparatus is mounted on said fuel pump reservoir, said plurality of fuel outlets communicating with the fuel pump reservoir to supply fuel directly into the fuel pump reservoir.

Further features and advantages of the invention will appear more clearly on a reading of the following detail description of the preferred embodiment of the invention, which is given by way of non-limiting example only and with reference to the accompanying drawings.

### BRIEF DESCRIPTION OF DRAWINGS

This invention will be further described with reference to the accompanying drawings in which:

FIG. 1 is a schematic view of a prior art jet pump apparatus.

FIG. 2 is a schematic view of a jet pump apparatus according to an embodiment of the present invention.

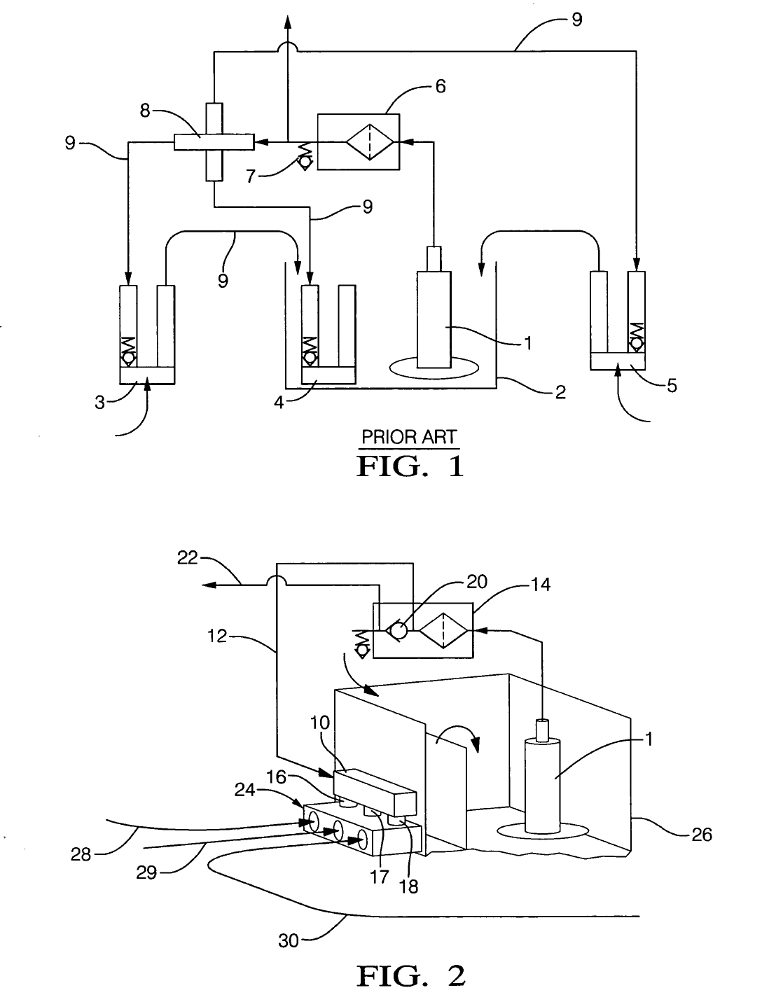

### DETAILED DESCRIPTION OF INVENTION

A preferred embodiment of the present invention is shown in FIG. 2. The jet pump apparatus comprises a fuel manifold 10 having an inlet connected via a fuel pipe 12 to the fuel pump 1 via the fuel filter assembly 14 and a plurality of outlets 16, 17, 18. A single anti-syphon check valve 20 is provided between the fuel pipe 12 and the engine fuel line 22 supplying fuel to the fuel system of the engine.

The fuel manifold 10 is mounted on a jet pump body 24 containing a plurality (three in the drawing) of jet pumps arranged in parallel within the jet pump body 24, whereby each outlet 16,17,18 from the manifold 10 is communicates with a respective jet pump.

The jet pump body 24 is mounted on a fuel pump reservoir 26 containing the fuel pump 1. Alternatively the jet pump body 24 may supply fuel to a fuel tank compartment in which the fuel pump 1 is disposed.

Each jet pump is of the aspirating type whereby fuel supplied from the fuel pump 1 via the fuel manifold 10 is passed through the throat of a venturi into which is supplied fuel from a fuel inlet connected to a fuel transfer pipe 28, 29, 30 communicating with a respective fuel tank compartment, whereby fuel from said respective compartment is entrained into said venturi throat and passed out of the respective jet pump into the fuel pump reservoir 26 or compartment. Thus the jet pump can be located adjacent the location to where fuel is to be supplied, obviating the need for delivery and, due to the proximity of the fuel manifold, a feed line.

Thus the present invention provides means for drawing fuel from multiple regions or compartments of a fuel tank by means of a plurality of jet pumps provided in a single jet pump body with pressurised fuel supplied from a common fuel manifold having a single anti-siphon check valve, thus using fewer components, greatly reducing cost and complexity, and using fewer connections, greatly simplifying in-tank assembly procedures.

Various modifications and variations to the described embodiment will be apparent to those skilled in the art without departing from the scope of the invention as defined in the appended claims.

Although the invention has been described in connection with a specific preferred embodiment, it should be understood that the invention as claimed should not be unduly limited to such specific embodiment.

We claim:

1. A jet pump apparatus for a vehicle fuel tank, the apparatus comprising
a fuel manifold having a fuel inlet connected to a fuel pump outlet and a plurality of fuel outlets; and
a plurality of jet pumps having a venturi;
wherein each jet pump further having jet pump inlet connectable to a fuel line for communication with a compartment of the fuel tank and an outlet adapted for fluid communication with reservoir containing a fuel pump inlet; and
wherein each fuel outlet of the fuel manifold communicating with the throat region of a venturi of a respective one of the plurality of jet pumps.

2. An apparatus in claim 1, wherein said plurality of jet pumps are provided in a common body or housing.

3. An apparatus in claim 2, wherein the fuel manifold is formed integrally with said body.

4. An apparatus in claim 3, further comprising an anti-syphon check valve provided upstream of the fuel inlet of the manifold.

5. An apparatus in claim 4, wherein each of said plurality of jet pumps comprises an aspiration jet pump.

6. An apparatus in claim 5, wherein said plurality of jet pumps are formed within a single jet pump body.

7. An apparatus in claim 6, wherein said jet pump body is mounted on a fuel pump reservoir.

8. An apparatus in claim 7, wherein said plurality of fuel outlets are in communication with the fuel pump reservoir to supply fuel directly into the fuel pump reservoir.

9. An apparatus in claim 1, further comprising an anti-syphon check valve provided upstream of the fuel inlet of the manifold.

10. An apparatus in claim 1, wherein each of said plurality of jet pumps comprises an aspiration jet pump.

11. An apparatus in claim 1, wherein said plurality of jet pumps are formed within a single jet pump body.

12. An apparatus in claim 2, further comprising an anti-syphon check valve provided upstream of the fuel inlet of the manifold.

13. An apparatus in claim 11, wherein said jet pump body is mounted on a fuel pump reservoir.

14. A fuel delivery module comprising a fuel pump mounted within a fuel pump reservoir, a jet pump apparatus as claimed in claim 1, wherein said jet pump apparatus is mounted on said fuel pump reservoir, said plurality of fuel outlets communicating with the fuel pump reservoir to supply fuel directly into the fuel pump reservoir.

15. A jet pump apparatus for a vehicle fuel tank, the apparatus comprising a fuel manifold having a fuel inlet connected to a fuel pump outlet and a plurality of fuel outlets; a plurality of jet pumps, each jet pump having an inlet connectable to a fuel line for communication with a compartment of the fuel tank and an outlet adapted for fluid communication with a main compartment or reservoir containing a fuel pump inlet; each fuel outlet of the fuel manifold communicating with the throat region of a venturi of a respective one of the plurality of jet pumps;
wherein said plurality of jet pumps are provided in a common body or housing;
wherein each of said plurality of jet pumps comprises an aspiration jet pump;
wherein said plurality of jet pumps are formed within a single jet pump body;
wherein said jet pump body is mounted on a fuel pump reservoir; and
wherein said plurality of fuel outlets are in communication with the fuel pump reservoir to supply fuel directly into the fuel pump reservoir.
